(19) United States
(12) Patent Application Publication
(10) Pub. No.: US 2012/0215858 A1
(43) Pub. Date: Aug. 23, 2012

(54) CACHING POTENTIALLY REPETITIVE MESSAGE DATA IN A PUBLISH-SUBSCRIPTION ENVIRONMENT

(75) Inventors: Kulvir S. Bhogal, Pflugerville, TX (US); Martin J. Gale, Hampshire (GB); Rick A. Hamilton, II, Charlottesville, VA (US); Andrew R. Jones, Round Rock, TX (US); Brian M. O'Connell, RTP, NC (US)

(73) Assignee: INTERNATIONAL BUSINESS MACHINES CORPORATION, Armonk, NY (US)

(21) Appl. No.: 13/032,974

(22) Filed: Feb. 23, 2011

(51) Int. Cl. G06F 15/16

(52) U.S. Cl. 709/206

(57) ABSTRACT

In general, embodiments of the present invention provide an approach for caching potentially repetitive data in a publication-subscription (pub/sub) system. Specifically, in a typical embodiment, when a message is received on a broker system from a publisher system, the broker system analyzes the message for potentially repetitive data. Such data can be determined from historical messages (e.g., determining that a certain set of data appeared in multiple messages and is thus flagged in a database or the like), a set of rules (e.g., if data set “Y” appears, flag it as potentially repetitive), etc. Regardless, once such a set of data has been identified, the set of data will be tagged/marked in the message with a unique identifier. The message and inserted unique identifier is then sent to the relevant subscriber system(s). Upon receiving the message, the subscriber system(s) will analyze the message, identify the unique identifier, and cache the tagged data. Thereafter, when the publisher system receives another message that contains the same set of data that was previously tagged, the publisher system will substitute the unique identifier for the repeated data to yield an abbreviated message. The publisher system will then send the abbreviated message to the subscriber system(s), which will analyze the abbreviated message, identify the unique identifier, and retrieve the associated data from cache. Thus, the substitution of unique identifiers for potentially repetitive data can avoid unnecessary communication of data and reduce overall network bandwidth consumption.

### TECHNICAL FIELD

The present invention relates to publish-subscription (pub/sub) environments. Specifically, the present invention relates to an approach for caching potentially repetitive data in a pub/sub environment.

### BACKGROUND

Publish-subscription (pub/sub) messaging patterns are communication models used in many different industries today. For example, pub/sub is used in banking systems, weather systems, and other systems that require techniques to notify multiple entities of common information. In general, pub/sub is a messaging paradigm where senders (publishers) of messages typically are not programmed to send their messages to specific receivers (subscribers). Rather, published messages can be characterized into classes, without knowledge of what (if any) subscribers there may be. Subscribers express interest in one or more classes, and can receive messages that are of interest, without knowledge of what publishers there are. This decoupling of publishers and subscribers can allow for greater scalability and a more dynamic network topology.

One deficiency in pub/sub models is that all of the content (i.e., the body/payload of the message) is sent to all users, and thus the amount of network traffic generated from the publisher is, in the simplest form, the size of the message multiplied by the number of subscribers. Moreover, it can be common for the same set of data to be re-sent multiple times (in different messages) to the same subscriber(s). As such, the volume of the data generated can be large and consume a great deal of network bandwidth.

### SUMMARY

In general, embodiments of the present invention provide an approach for caching potentially repetitive data in a publication-subscription (pub/sub) system. Specifically, in a typical embodiment, when a message is received on a broker system from a publisher system, the broker system analyzes the message for potentially repetitive data. Such data can be determined from historical messages (e.g., determining that a certain set of data appeared in multiple messages and is thus flagged in a database or the like), a set of rules (e.g., if data set “Y” appears, flag it as potentially repetitive), etc. Regardless, once such a set of data has been identified, the set of data will be tagged/marked in the message with a unique identifier. The message and inserted unique identifier is then sent to the relevant subscriber system(s). Upon receiving the message, the subscriber system(s) will analyze the message, identify the unique identifier, and cache the tagged data. Thereafter, when the publisher system receives another message that contains the same set of data that was previously tagged, the publisher system will substitute the unique identifier for the repeated data to yield an abbreviated message. The publisher system will then send the abbreviated message to the subscriber system(s), which will analyze the abbreviated message, identify the unique identifier, and retrieve the associated data from cache. Thus, the substitution of unique identifiers for potentially repetitive data can avoid unnecessary communication of data and reduce overall network bandwidth consumption.

A first aspect of the present invention provides a method for caching potentially repetitive message data in a publish-subscription (pub/sub) messaging environment, comprising: identifying a set of data in a first message, the set of data having a potential to appear in at least one future message; tagging the set of data with a unique identifier; sending the first message with the unique identifier to a subscriber system; receiving a second message having the set of data; substituting the unique identifier for the set of data in the second message to yield an abbreviated message; and sending the abbreviated message to the subscriber system.

A second aspect of the present invention provides a system for caching potentially repetitive message data in a publish-subscription (pub/sub) messaging environment, comprising: a bus; a processor coupled to the bus; and a memory medium coupled to the bus, the memory medium comprising instructions to: identify a set of data in a first message, the set of data having a potential to appear in at least one future message; tag the set of data with a unique identifier; send the first message with the unique identifier to a subscriber system; receive a second message having the set of data; substitute the unique identifier for the set of data in the second message to yield an abbreviated message; and send the abbreviated message to the subscriber system.

A third aspect of the present invention provides a computer program product for caching potentially repetitive message data in a publish-subscription (pub/sub) messaging environment, the computer program product comprising a computer readable storage media, and program instructions stored on the computer readable storage media, to: identify a set of data in a first message, the set of data having a potential to appear in at least one future message; tag the set of data with a unique identifier; send the first message with the unique identifier to a subscriber system; receive a second message having the set of data; substitute the unique identifier for the set of data in the second message to yield an abbreviated message; and send the abbreviated message to the subscriber system.

A fourth aspect of the present invention provides a method for deploying a system for caching potentially repetitive message data in a publish-subscription (pub/sub) messaging environment, comprising: deploying a computer infrastructure being operable to: identify a set of data in a first message, the set of data having a potential to appear in at least one future message; tag the set of data with a unique identifier; send the first message with the unique identifier to a subscriber system; receive a second message having the set of data; substitute the unique identifier for the set of data in the second message to yield an abbreviated message; and send the abbreviated message to the subscriber system.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computing node according to an embodiment of the present invention.

FIG. 2 depicts a pub/sub environment according to an embodiment of the present invention.

FIG. 3 depicts a component flow diagram according to an embodiment of the present invention.

FIG. 4 depicts another component flow diagram according to an embodiment of the present invention.

FIG. 5 depicts another component flow diagram according to an embodiment of the present invention

FIG. 6 depicts a method flow diagram according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments now will be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

As indicated above, embodiments of the present invention provide an approach for caching potentially repetitive data in a publication-subscription (pub/sub) system. Specifically, in a typical embodiment, when a message is received on a broker system from a publisher system, the broker system analyzes the message for potentially repetitive data. Such data can be determined from historical messages (e.g., determining that a certain set of data appeared in multiple messages and is thus flagged in a database or the like), a set of rules (e.g., if data set “Y” appears, flag it as potentially repetitive), etc. Regardless, once such a set of data has been identified, the set of data will be tagged/marked in the message with a unique identifier. The message and inserted unique identifier is then sent to the relevant subscriber system(s). Upon receiving the message, the subscriber system(s) will analyze the message, identify the unique identifier, and cache the tagged data. Thereafter, when the publisher system receives another message that contains the same set of data that was previously tagged, the publisher system will substitute the unique identifier for the repeated data to yield an abbreviated message. The publisher system will then send the abbreviated message to the subscriber system(s), which will analyze the abbreviated message, identify the unique identifier, and retrieve the associated data from cache. Thus, the substitution of unique identifiers for potentially repetitive data can avoid unnecessary communication of data and reduce overall network bandwidth consumption.

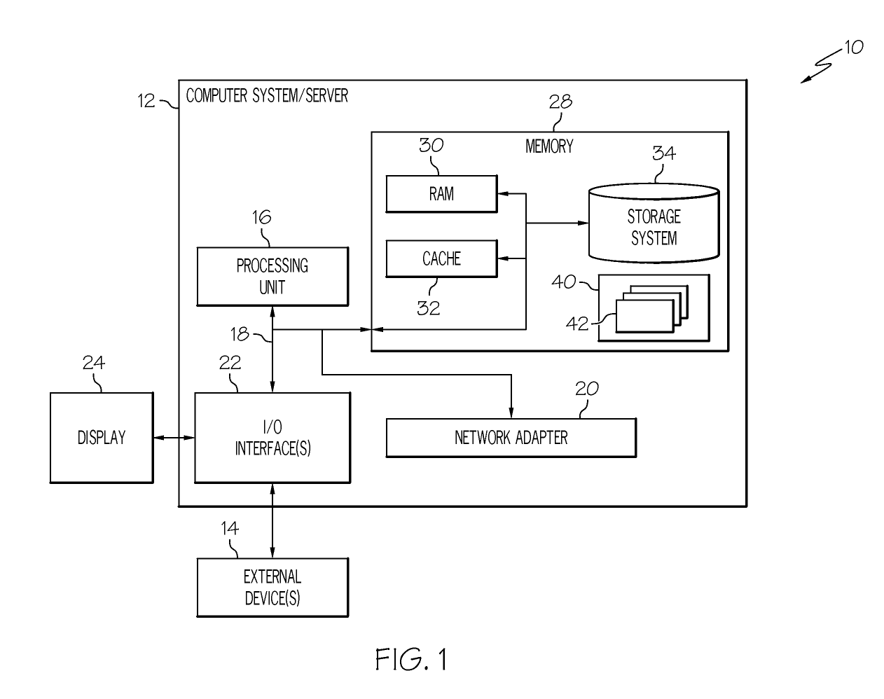

Referring now to FIG. 1, a schematic of an example of a computing node is shown. Computing node 10 is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10, there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

The embodiments of the invention may be implemented as a computer readable signal medium, which may include a propagated data signal with computer readable program code embodied therein (e.g., in baseband or as part of a carrier wave). Such a propagated signal may take any of a variety of forms including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium including, but not limited to, wireless, wireline, optical fiber cable, radio-frequency (RF), etc., or any suitable combination of the foregoing.

Program/utility 40, having a set (at least one) of program modules 42, may be stored in memory 28 by way of example, and not limitation, as well as an operating system, one or more application programs, other program modules, and program data. In general, program/utility 40 performs the function of the present invention as described herein. Each of the operating systems, one or more application programs, other program modules, and program data or some combination thereof, may include an implementation of a networking environment. Program modules 42 generally carry out the functions and/or methodologies of embodiments of the invention as described herein. Computer system/server 12 may also communicate with one or more external devices 14 such as a keyboard, a pointing device, a display 24, etc.; one or more devices that enable a consumer to interact with computer system/server 12; and/or any devices (e.g., network card, modem, etc.) that enable computer system/server 12 to communicate with one or more other computing devices. Such communication can occur via I/O interfaces 22.

Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

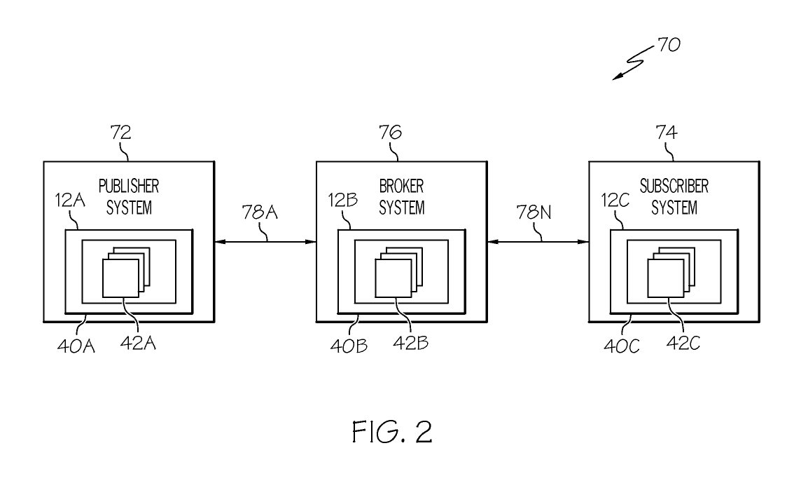

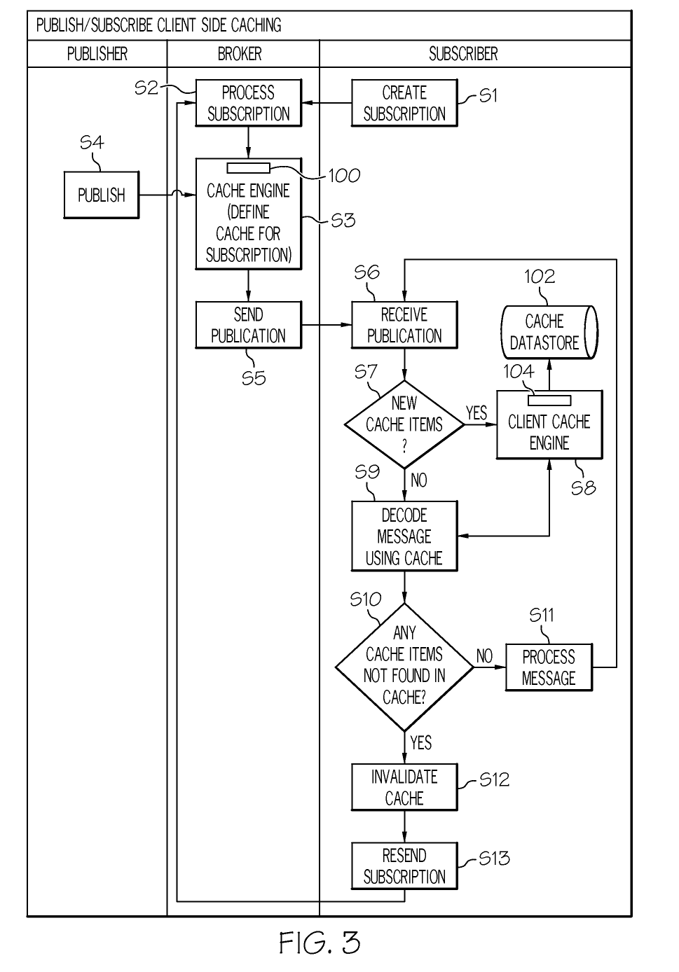

Embodiments of the present invention provide an approach for a client-side cache that can be utilized to reduce the volume of data (network traffic) delivered to individual subscribers in a pub/sub system. Referring now to FIG. 2, a pub/sub environment 70 in accordance with at least one embodiment of the present invention is shown in greater detail. As depicted, environment 70 comprises a publisher system 72 (also referred to below as “publisher”) in communication with a subscriber system 74 (also referred to below as “subscriber”) via a broker system 76 (also referred to below as “broker”). Systems 72, 74, and 76 communicate via network links 78A-N, which can represent any type of network links and/or communication networks now known or later developed. It is understood that publisher system 72, subscriber system 74, and broker system 76 each comprise one or more computer systems 12A-C (e.g., which comprises components/elements similar to computer system 12 of FIG. 1). As such, publisher system 72, subscriber system 74, and broker system 76 can each comprise a program/utility 40A-C that enable corresponding functions thereof. Specifically, publisher system 72 comprises publisher program 40A having a set (at least one) of publisher program modules 42A, broker system 76 comprises broker program 40B having a set of broker program modules 42B, and subscriber system 74 comprises a subscriber program 40C having a set of subscriber program modules 42C. Program modules 42A-C of programs 40A-C typically enable/perform the functions that will be described below in conjunction with FIGS. 3-5.

As will be further described below, pub/sub system 70 can generally enable one or more of the following operations:
Broker system 76 identifies data (binary, text, etc.) in a message that has a potential to be repeated (e.g., data potentially repeating across messages);
Broker system 76 uniquely tags/marks this data to be cached by subscriber system 74 (e.g., with a unique identifier/cache mark);
Broker system 76 sends the initial message to subscriber system 74 with marked/tagged data;
Subscriber system 74 receives the initial message;
Subscriber system 74 identifies data marked/tagged to be cached;
Subscriber system 74 caches marked data (e.g., on broker system 76 and/or subscriber system 76);
When a subsequent publication/message arrives from publisher system 72, broker system 76 looks for previously identified (e.g., cached) data (e.g., data has been repeated);
Broker system 76 substitutes repeated data with the unique identifier/cache marks to yield an abbreviated message;
Broker system 76 sends the abbreviated message to subscriber system 74; and/or
Subscriber system 74 identifies the unique identifier and retrieves the corresponding data from cache to reveal/yield the full message.

Additionally described in the details section below are methods for clients to identify themselves as supporting client-side cache, for client to invalidate their cache with the server, other common cache related methods, and potential means of implementation and other optimizations.

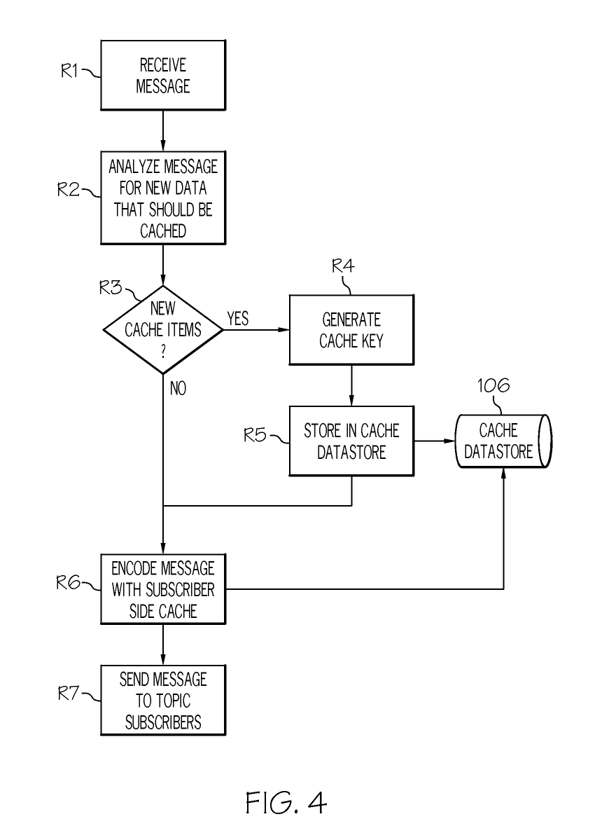

These concepts will be more fully described in conjunction with the component flow diagrams of FIGS. 3-5. Referring first to FIG. 3, in step S1, a subscriber creates a subscription (e.g., to a topic or the like) that the broker system processes in step S2. It is understood that this initial message could contain a custom header or some other indication that the client supports a client-side cache. In one embodiment, a cache engine 100 (e.g., part of broker system program 40B of FIG. 2) identifies data (binary, text, etc.) that should be cached by the client in step S3. Along these lines, cache engine 100 can use intelligent rules to identify likely data that will be used repeatedly in messages sent to this subscription as publications/messages are received from publishers in step S4. One element of this approach is the creation of a unique key for a set of data in the message that has a potential to be repeated in subsequent messages. Specifically, such a set of data will be tagged/marked with the unique key before the message is passed along to the subscriber (thus alerting the subscriber to the presence of potentially repetitive and cacheable data). In this embodiment, the cache and the set of keys created could be specific to the publisher or to all publishers handled by the broker system (one or more topics). The functions provided by cache engine 100 are described in more detail in FIG. 4. However, if this is the first time a unique identifier/key is used in a message to a topic's subscribers, the key and its associated data are added to the message. This key/data combination may be added as a custom header to the message, as a sub-part of the message body (e.g., Multi-Purpose Internet Mail Extension (MIME) type/part), or using some similar method. The message is then sent to the subscriber(s) of a topic in step S5. When a subscriber receives a publication in step S6, it is processed. Specifically, it is determined in step S7 whether new cache items are found. In one embodiment, the subscriber will analyze/review the message, identify/locate the unique identifier, and cache the set of data associated therewith in cache/data store 102 via client cache engine 104 of step S8. Note that, in many cases, the first message may contain a large number of items to be cached. Also, the cache 102 created can be a per-topic cache, or a more system wide cache which can be used for more than one topic subscription.

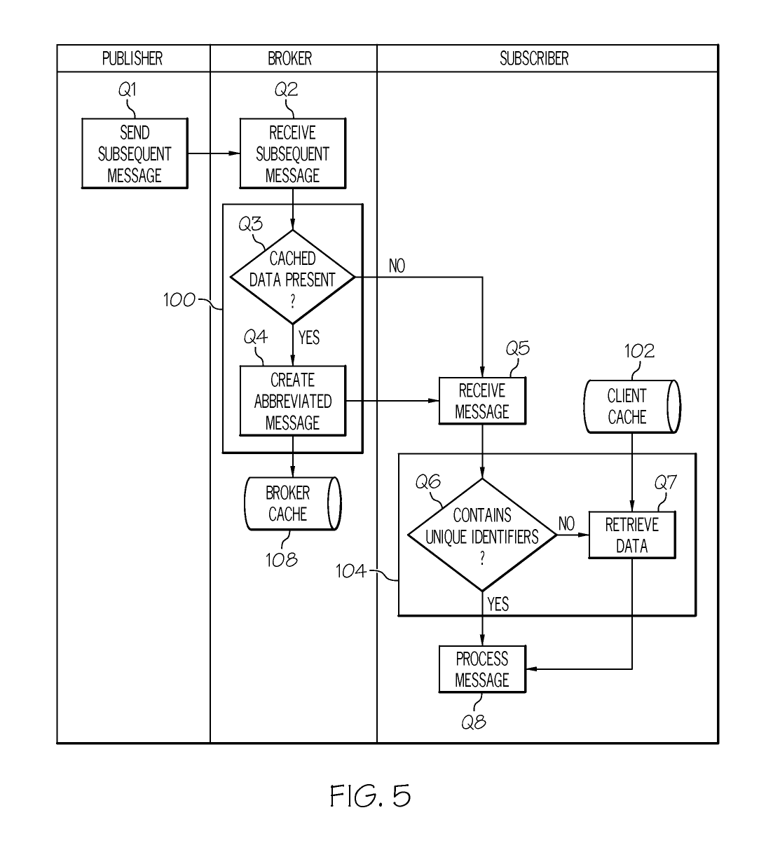

As further shown in FIG. 3, once all potentially repetitive data items have been added to cache 102 and no more appear to be present (as determined in step S7), the message can be decoded in step S9. In step S10, it is determined whether the message contained other unique keys in place of data (as opposed to keys/unique identifiers tagged to data), which are indicative of data that was cached from a previous message (as described below in conjunction with FIG. 5). Specifically, step S10 will also determine if such keys/unique identifiers are invalid. If not, the data is retrieved, and the message is processed in step S11. If unidentifiable keys/unique identifiers are located in the message in step S10, the cache and/or message can be invalidated in step S12 and the subscription resent in step S13.

Referring now to FIG. 4, the functions of broker system cache engine 100 will be described. As depicted, a new message is received in step R1 and analyzed for data that can be cached in step R2. Step R2 can entail one or more algorithms for determining what data should be cached. This may include rules such as historical analysis (e.g., have the same text in “n” of the last “m” messages), predefined knowledge about expected messages (e.g. messages using known schemas), etc. Regardless, once the algorithms are applied and cacheable data is identified in step R3, cache keys/unique identifiers are created in step R4 (e.g., for each data fragment) and stored in step R5 in the broker system cache/datastore 106. The message is then encoded with the proper cached data R6 and unique identifier (e.g., per an implementation like those described in the Illustrative Implementation sections below) and sent to subscriber(s) of the topic in step R7.

Referring now to FIG. 5, a component flow diagram is shown that depicts the process when a subsequent message that potentially contains previously cached data is received. As depicted in step Q1, the publisher sends a message that is received by the broker system in step Q2. In step Q3, the publisher will determine whether cached data is present. If so, the corresponding keys/unique identifiers will be retrieved from broker system cache 108, and substituted for the previously cached data to yield/create an abbreviated message in step Q4 that is sent to the subscriber. As shown, the functions of step Q3 and Q4 can be enabled by broker system cache engine 100. Regardless, if no repeated (previously cached) data was present in the subsequent message, the subsequent message can be sent “as is.” The subsequent (possibly abbreviated) message is received by the subscriber in step Q5. Upon receipt, subscriber/client cache engine 104 will determine whether the received message contains keys/unique identifiers in step Q6. As indicated, the presence of keys/unique identifier in a sequence of data (as opposed to being tagged to a specific piece of data) indicates to the subscriber that corresponding data must be retrieved from client cache 104 in step Q7. Once any needed data is retrieved, the message can be processed in step Q8.

In one embodiment, it could be beneficial to allow a broker system to invalidate cache items on the client. If, for example, the broker system's cache engine 100 can determine that data previously cached is never used again, or has a very low likelihood of being used again, it may send an invalidation message upon the next publish to the client. This may be implemented as a custom header that contains the key and an invalidated directive. The client/subscriber cache engine 104, upon receiving and reading the message, will simply remove the cached item from its cache.

Additional aspects of the system:
The cache data store 102 illustrated above can be either in-memory or an on-disk data store (e.g. database like DB2, flat file, binary file, binary encrypted file, etc.).
The broker system's cache engine 100 may attach an expiration time for each key. This value could be used by the client side cache to invalidate cache entries and may be useful to limit the growth of the cache.
The broker system could send a subsequent message (to both publishers and clients) that would invalidate certain cache entries (e.g., it determines that data will never be used again).
The broker system's cache engine 100 can support automatic cache creation as described earlier. For example, if the last N number of messages on a topic contains a common data segment, then that data segment should be marked for caching and a cache key/data pair created and sent with the next message.

### Illustrative Implementations

### Illustrative Implementation I

As the broker system identifies data to be cached, when it creates a message that contains data that should be in the client's cache, engine 100 either deletes or substitutes the cached data with the appropriate cache key (the system that allows for the data to be deleted is described below). For example, assume that the message being sent appears as follows:
AAAAAABBBBBBBCCCCCCDDDDDDEEEEEEE

The broker system indicates that the “B's” of the message will likely be used in future messages and instructs subscribers (both publishers and subscriber systems) that both should retain the portion in their local cache. In this example, the broker system informs subscriber that they need to refer to this portion BBBBBBB as ˜rp1. How to identify repeated portions will be user specifiable and the escape sequences to identify repeated portions will be user specifiable as well. The subscriber will store the portion BBBBBBB and analyze incoming messages for the presence of ˜rp1.

Further assume that at some future point in time, a publisher wants to send a message that appears as follows:
FFFFFFFFBBBBBBBUUUUUUJJJJJJJJ
   Rather than sending this message, it can now send the following:
FFFFFFFF˜rp1UUUUUUJJJJJJJJ
   This allows for the sender to send less traffic on the network. Upon receipt of this message, the subscriber will then reconstruct the message based on translation information from its cache and create the following message:
FFFFFFFFBBBBBBBUUUUUUJJJJJJJJ
   After expanding ˜rp1 to BBBBBBB.

### Illustrative Implementation II

If it was desired, for example, that cached data be inserted at the 12th position of the message, then a property (or custom header) would be provided that indicates rp1=12,x,y (where rp1 is the cache key, and 12 is the first position to insert the data, x is the next, y is the next, and so on). This method prevents having to escape any un-cached message data that matches a cache indicator.

### Illustrative Implementation III

Another possible storage key mechanism is the use of Cyclic Redundancy Check (CRC) or similar technologies. By publishing the repeating data field, and an indication that this is a repeating (e.g., cacheable) field, the broker system may likewise either send the CRC or allow the subscriber system to calculate that data field's CRC. Subsequent cache retrieval instructions can be made by using this CRC as a unique identifier of the cacheable data to be retrieved.

Under embodiments of the present invention, multiple approaches may be included in these solutions. Specifically, several techniques may be implemented to identify cacheable information. The techniques identified below may be used independently or in conjunction with each other.

Differencing Engine: This approach analyzes messages either within a single topic, or across multiple topics capturing the similarities between messages. The most similar aspects of the messages are good candidates for future caching. The similarities captured may be persisted across restarts such that caching efficiency is not interrupted. The items cached may change over time as the message profiles change. For example if one type of message is dominant for a period of time, then a second disparate message type is dominant, cache entries related to the first type may be invalidated to make room for the second type.

Rate-Based Selection: It may be common for some messages and topics to have a higher rate of publishing than others. This rate may be related to the importance or the dynamic nature of the subject for each particular topic. Topics with a higher publication rates should be selected for caching before topics with a lower publication rate. Rate-based selection counts the total number of messages per topic, or message types within a single topic, and selects the most published topics or message types for message portion caching.

Message Correlation Selection: The system may discern correlations between related topics and therefore cache the potential similarities for the related topics upon detection of the first message. For example, there may be related topics of /scores/[court]/ and /stats/[court] where court is a changing topic related to particular players on a particular cart. Every message published to a /stats/[court] is preceded by a message published to /scores/[court]. Both sets of messages may identify the player names for that particular court. Therefore, this method may discern that for every message published to /scores/[court] and /stats/[court] that while components of the message change (current score, current stats) the player names stay the same. Therefore, for a short period of time after a message is published to /scores/[court] the player name component is eligible for caching until the corresponding /stats/[court] message is sent.

Finally, it is noted that different methods of signifying data entities may be used by both senders and recipients of data. These methods include universal hashing, hashing with checksums, rolling hashes, or even cryptographic hash functions, should security dictate. Each of these approaches offers certain advantages and can be used to speed and ease the implementation of any concepts described in this disclosure.

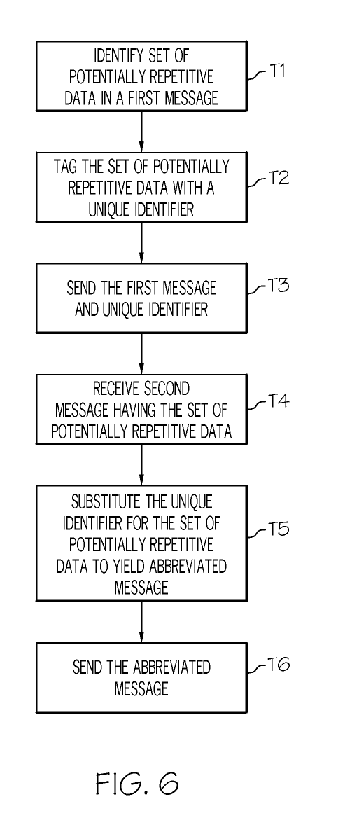

Referring now to FIG. 6, a method flow diagram according to an embodiment of the present invention is shown. In step T1, a set of data having a potential to appear in at least one future message is identified (on a broker system). In step T2, the set of data is tagged with a unique identifier. In step T3, the first message and the unique identifier are sent to a subscriber system. As indicated above, the subscriber system will identify the unique identifier and cache the set of (tagged) data accordingly. In step T4, a second message having the set of data is received (on the broker system). In step T5, the unique identifier is substituted for the set of data in the second message to yield an abbreviated message. In step T6, the abbreviated message is sent to the subscriber system. The subscriber system can then use the unique identifier to retrieve the set of data from cache and view the complete message (e.g., replace the unique identifier therewith).

While shown and described herein as data caching solution, it is understood that the invention further provides various alternative embodiments. For example, in one embodiment, the invention provides a computer-readable/useable medium that includes computer program code to enable a computer infrastructure to provide data caching functionality as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 28 (FIG. 1) and/or storage system 34 (FIG. 1) (e.g., a fixed disk, a read-only memory, a random access memory, a cache memory, etc.).

In another embodiment, the invention provides a method that performs the process of the invention on a subscription, advertising, and/or fee basis. That is, a service provider, such as a Solution Integrator, could offer to provide data caching functionality. In this case, the service provider can create, maintain, support, etc., a computer infrastructure, such as computer system 12 (FIG. 1) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for providing data caching functionality. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

As used herein, it is understood that the terms “program code” and “computer program code” are synonymous and mean any expression, in any language, code, or notation, of a set of instructions intended to cause a computing device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular computing device, and the like.

A data processing system suitable for storing and/or executing program code can be provided hereunder and can include at least one processor communicatively coupled, directly or indirectly, to memory elements through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output and/or other external devices (including, but not limited to, keyboards, displays, pointing devices, etc.) can be coupled to the system either directly or through intervening device controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable 1ems, and Ethernet cards.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A method for caching potentially repetitive message data in a publish-subscription (pub/sub) messaging environment, comprising:
identifying a set of data in a first message, the set of data having a potential to appear in at least one future message;
tagging the set of data with a unique identifier;
sending the first message with the unique identifier to a subscriber system;
receiving a second message having the set of data;
substituting the unique identifier for the set of data in the second message to yield an abbreviated message; and
sending the abbreviated message to the subscriber system.

2. The method of claim 1, further comprising:
reviewing the first message on the subscriber system;
identifying the unique identifier; and
caching the data in a cache.

3. The method of claim 2, further comprising:
receiving the abbreviated message on the subscriber system;
identifying the unique identifier; and
retrieving the set of data from the cache.

4. The method of claim 1, the potential being indentified based on an appearance of the set of data in at least one message received prior to the first message.

5. The method of claim 1, the first message and the second message being received on a broker system from a publisher system.

6. The method of claim 5, the broker system, the publisher system, and the subscriber system each being computerized systems in the pub/sub messaging environment.

7. The method of claim 5, the broker system, the publisher system, and the subscriber system communicating over at least one type of computer network.

8. A system for caching potentially repetitive message data in a publish-subscription (pub/sub) messaging environment, comprising:
a bus;
a processor coupled to the bus; and
a memory medium coupled to the bus, the memory medium comprising instructions to:
identify a set of data in a first message, the set of data having a potential to appear in at least one future message;
tag the set of data with a unique identifier;
send the first message with the unique identifier to a subscriber system;
receive a second message having the set of data;
substitute the unique identifier for the set of data in the second message to yield an abbreviated message; and
send the abbreviated message to the subscriber system.

9. The system of claim 8, the memory medium further comprising instructions to:
review the first message on the subscriber system;
identify the unique identifier; and
cache the data in a cache.

10. The system of claim 9, the memory medium further comprising instructions to:
receive the abbreviated message on the subscriber system;
identify the unique identifier; and
retrieve the set of data from the cache.

11. The system of claim 8, the potential being indentified based on an appearance of the set of data in at least one message received prior to the first message.

12. The system of claim 8, the first message and the second message being received on a broker system from a publisher system.

13. The system of claim 12, the broker system, the publisher system, and the subscriber system each being computerized systems in the pub/sub messaging environment.

14. The system of claim 12, the broker system, the publisher system, and the subscriber system communicating over at least one type of computer network.

15. A computer program product for caching potentially repetitive message data in a publish-subscription (pub/sub) messaging environment, the computer program product comprising a computer readable storage media, and program instructions stored on the computer readable storage media, to:
identify a set of data in a first message, the set of data having a potential to appear in at least one future message;
tag the set of data with a unique identifier;
send the first message with the unique identifier to a subscriber system;
receive a second message having the set of data;
substitute the unique identifier for the set of data in the second message to yield an abbreviated message; and
send the abbreviated message to the subscriber system.

16. The computer program product of claim 15, further comprising program instructions stored on the computer readable storage media to:
review the first message on the subscriber system;
identify the unique identifier; and
cache the data in a cache.

17. The computer program product of claim 16, further comprising program instructions stored on the computer readable storage media to:
receive the abbreviated message on the subscriber system;
identify the unique identifier; and
retrieve the set of data from the cache.

18. The computer program product of claim 15, the potential being indentified based on an appearance of the set of data in at least one message received prior to the first message.

19. The computer program product of claim 15, the first message and the second message being received on a broker system from a publisher system.

20. The computer program product of claim 19, the broker system, the publisher system, and the subscriber system each being computerized systems in the pub/sub messaging environment.

21. The computer program product of claim 19, the broker system, the publisher system, and the subscriber system communicating over at least one type of computer network.

22. A method for deploying a system for caching potentially repetitive message data in a publish-subscription (pub/sub) messaging environment, comprising:
deploying a computer infrastructure being operable to:
identify a set of data in a first message, the set of data having a potential to appear in at least one future message;
tag the set of data with a unique identifier;
send the first message with the unique identifier to a subscriber system;
receive a second message having the set of data;
substitute the unique identifier for the set of data in the second message to yield an abbreviated message; and
send the abbreviated message to the subscriber system.
